(19) United States
(12) Patent Application Publication
(10) Pub. No.: US 2023/0034242 A1
(43) Pub. Date: Feb. 2, 2023

(54) ANTHROPOMORPHIC TEST DEVICE WITH SHOULDER ASSEMBLY, USE OF SAID TEST DEVICE AND MANUFACTURE OF A SHOULDER ASSEMBLY FOR AN ANTHROPOMORPHIC TEST DEVICE

(71) Applicant: Kistler Holding AG, Winterthur (CH)

(72) Inventors: Thomas Warkentin, Heiligkreuzsteinach (DE); Jost Einar Griesemann, Bruehl (DE); Alexander Schmitt, Hirschhorn (DE)

(21) Appl. No.: 17/870,918

(22) Filed: Jul. 22, 2022

(30) Foreign Application Priority Data
Jul. 30, 2021 (EP) 21188966.2

(51) Int. Cl. G01M 17/007; G09B 23/30; B33Y 80/00; B29C 39/10

(52) U.S. Cl. CPC G01M 17/0078; G09B 23/30; B33Y 80/00; B29C 39/10; B29K 2075/00

(57) ABSTRACT

An anthropomorphic test device includes a spine assembly substantially extending along a spine axis; a clavicle assembly substantially extending radially from the spine assembly; an arm assembly spaced radially from the spine assembly; and a shoulder assembly connected to the clavicle assembly and disposed adjacent to the arm assembly and defining a proximal portion that is disposed proximal to the spine assembly and a distal portion that is disposed distal to the spine assembly. The shoulder assembly includes a seat belt portion disposed between the proximal portion and the distal portion and having an elasticity that differs from the elasticity of the distal portion.

### TECHNICAL FIELD

The invention relates to an anthropomorphic test device comprising a shoulder assembly. The invention also relates to the use of said test device. Furthermore, the invention relates to the manufacture of a shoulder assembly for an anthropomorphic test device.

### BACKGROUND OF THE INVENTION

Anthropomorphic test devices are mostly used for so-called vehicle crash tests. In these cases, the anthropomorphic test device assists in detecting the effect of a collision of a vehicle on a human being sitting in the vehicle. For this purpose, an anthropomorphic test device equipped with sensors is positioned instead of a human being in the vehicle during crash tests. The anthropomorphic test device at least partially mimics a human being in shape or in shape and weight.

An anthropomorphic test device, hereinafter also shortly referred to as a test device, has been known for many years and is also commonly referred to as a crash test dummy. One type of test device is known as a THOR dummy. A test device is often equipped with a plurality of sensors that detect one or more physical variables in the test device or in parts of the test device. In the following explanation, parts or areas of the test device are referred to by the names of human body parts or body areas. It should be understood that in a test device that mimics the human body a body part denoted in this manner has a position identical to the respective part in the human body.

Prior to a collision of the vehicle to be tested, the test device is generally positioned within the vehicle according to specifications of a test description, usually in a position identical to that of a human being. The test description is dictated by governmental regulations. During the impact, the test device should behave as much as possible like a human body. For this purpose, a test device comprises biomechanical components that during an impact should behave as identical as possible to the corresponding elements in a human body. For example, biomechanical components include arms with elbow joints, the spine comprising the area of the cervical vertebrae supporting a head, a chest, or a shoulder.

Prior to a collision, a test device is placed on a seat in a vehicle, often buckled by a so-called three-point seat belt. The belt strap of a three-point seat belt is typically secured to a vehicle body at three points: usually to one point in the lower portion of the B pillar, another point is the so-called belt lock, and a third connection point usually is in the upper portion of the B pillar. The belt strap passes from the first point across the pelvis of the test device to the second point, and from the second point across the chest over the shoulder to the third point. Often, a seat belt is also referred to as a restraint belt or safety belt. A locked seat belt passes over the shoulder of a person secured in a vehicle by the seat belt. In an analogous manner, in the sense of the present invention, a locked seat belt passes over a shoulder assembly of the test device.

In addition, a vehicle may be formed as a so-called test sled comprising a vehicle seat and fastening means for a seat belt. Test sleds of this type are often accelerated linearly and then decelerated abruptly for simulating a collision. Test sleds are often used to test child safety seats or seat belts, belt locks, belt tensioners and the like. In the following explanation, when mention is made of a vehicle this may also refer to a test sled.

According to the prior art, the shoulder of a test device comprises a shoulder assembly that is usually made of plastic. Typically, the shoulder assembly is made of one piece, for example molded as one piece. The shoulder assembly comprises an area proximal to the spine that extends substantially parallel to the spine. The shoulder assembly comprises an area distal to the spine that is radially spaced away from the spine and substantially extends in a radial direction from the spine.

A study called “Effects of Shoulder-belt Slip on the Kinetics and Kinematics of the THOR” by Suzanne Tylko, Kathy Tang, François Giguère, and Alain Bussières, 2018 IRCOBI Conference Proceedings, 12-14 Sep. 2018—Athens (Greece), found that a shoulder assembly according to the prior art bears the risk that during an impact, the seat belt may slip off the shoulder and into a gap between the spine assembly and the proximal portion of the shoulder assembly. With a seat belt displaced in such a manner, the behavior of the test device during an impact is no longer identical to that of a human body.

A shoulder assembly is known from DE102019216967A1, which corresponds to US Patent Application Publication No. 2020-0143709, which by this reference is hereby incorporated herein in its entirety for all purposes, which is designed to prevent such slipping of the seat belt as mentioned above. The shoulder assembly is made of two parts wherein a clavicle portion is formed from a first thermosetting material and a neck portion is formed from a second thermosetting material. The neck portion is more rigid than the clavicle portion. The neck portion and clavicle portion are made to engage each other with flanges of the clavicle portion engaging slots of the neck portion. Therefore, mounting of the shoulder assembly to the test device is complex because two parts, the clavicle portion and the neck portion, must be mounted or require a previous mounting step for joining these two parts. Furthermore, there is a weakness in the joining area of flanges and slots so that they may lose contact to each other during an impact.

### OBJECTS AND SUMMARY OF THE INVENTION

It is an object of the invention to provide a shoulder assembly that avoids the disadvantages mentioned above. It is another object of the invention to provide a shoulder assembly that avoids slipping of a seat belt during an impact and which can be mounted in a simple and efficient manner. It is a further object of the present invention to provide a method of manufacturing a shoulder assembly with the features described below as original equipment. It is an additional object of the present invention to provide a process by which a pre-existing shoulder assembly can be retrofitted with the features described below.

These objects and others have been achieved by the features described hereinafter.

The present invention relates to an anthropomorphic test device, shortly referred to as a test device, wherein said test device comprises a spine assembly; wherein said spine assembly substantially extends along a spine axis; wherein said test device comprises at least one clavicle assembly; wherein said test device comprises at least one upper arm assembly; wherein said clavicle assembly substantially extends radially from the spine assembly; wherein said arm assembly is radially spaced away from the spine assembly; wherein said test device comprises a shoulder assembly; wherein said shoulder assembly is connected to the clavicle assembly; wherein said shoulder assembly is arranged adjacent to said arm assembly; wherein said shoulder assembly comprises a portion proximal to the spine assembly; wherein said shoulder assembly comprises a portion distal to the spine assembly; wherein said shoulder assembly comprises a seat belt portion; wherein said seat belt portion is arranged between the proximal portion and the distal portion; and wherein the elasticity of the seat belt portion is different from the elasticity of the distal portion.

The clavicle assembly is connected to a chest assembly. The chest assembly is connected to the spine assembly. The arm assembly is connected to the clavicle assembly.

The test device is used in a vehicle that includes a restraint device. The restraint device comprises at least a seat belt and a seat. The test device is typically arranged on the seat, and the seat belt is guided to be in contact with the shoulder assembly. The seat belt contacts the shoulder assembly in the seat belt portion.

The differential elasticity of the seat belt portion and the distal portion of the shoulder assembly of the test device prevents the seat belt of a vehicle from slipping during a vehicle collision.

In a first embodiment of the test device according to the invention, said slipping of the seat belt is prevented by a seat belt portion having a lower elasticity as compared to the distal portion. Lower elasticity means that the seat belt portion is more rigid. The seat belt portion is less deformable than the distal portion. During a vehicle collision, the vehicle is stopped abruptly. The test device is pressed against the seat belt because of its inertial mass. The seat belt exerts a force on the test device, in particular on the seat belt portion of the shoulder assembly. The lower elasticity of the seat belt portion prevents mechanical twisting or folding of the seat belt portion. The seat belt remains in the seat belt portion during the impact.

In a second embodiment of the test device according to the invention, slipping of the seat belt is prevented by a seat belt portion having a higher elasticity as compared to the distal portion. Higher elasticity means that the seat belt portion is softer. The seat belt portion is more deformable than the distal portion. During a vehicle collision, the vehicle is stopped abruptly. The test device is pressed against the seat belt because of its inertial mass. The seat belt exerts a force on the test device, in particular on the seat belt portion of the shoulder assembly. The seat belt sinks into the seat belt portion because the seat belt portion is more elastic. This forms a depression in the seat belt portion. This depression functions as a guiding means for the seat belt. Lateral slipping of the seat belt is prevented by the edges of the depression.

### BRIEF DESCRIPTION OF THE SEVERAL VIEWS OF EXEMPLARY DRAWINGS

In the following, the invention is explained in more detail by way of example with reference to the figures in which:

FIG. 1 shows a schematic partial view of an embodiment of a test device comprising a shoulder assembly;

FIG. 2 shows a schematic partial view of an embodiment of a test device comprising a shoulder assembly and a seat belt arranged over the shoulder assembly;

FIG. 3 shows a schematic partial perspective view of a shoulder assembly;

FIG. 4 shows a view of a section through a schematic partial perspective view of a shoulder assembly;

FIG. 5 shows a schematic representation of a test device within a vehicle;

FIG. 6 shows a cross-sectional view of a schematic representation of a hollow mold; and

FIG. 7 shows a schematic representation of an embodiment of a test device in which only the right shoulder assembly and the spine assembly are shown.

Throughout the figures, identical reference numerals refer to identical objects.

### DETAILED DESCRIPTION OF EXEMPLARY EMBODIMENTS OF THE INVENTION

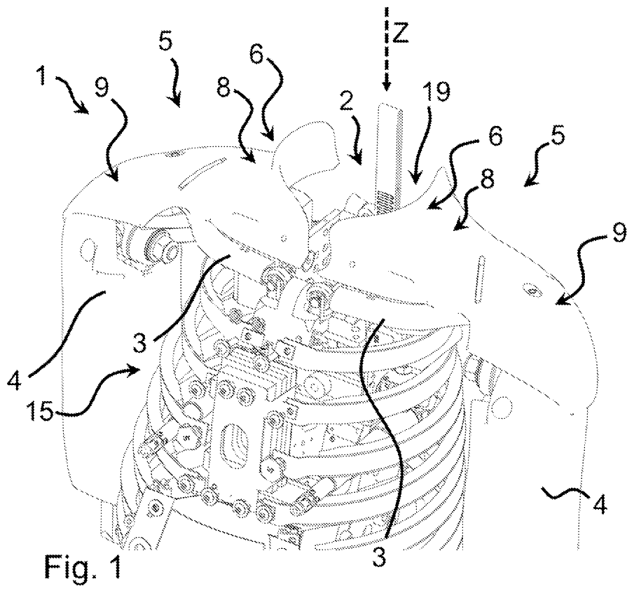

FIG. 1 shows a schematic partial perspective view of an embodiment of a test device 1 comprising a shoulder assembly that is generally designated by the numeral 5. The test device comprises a spine assembly that is generally designated by the numeral 2. The spine assembly 2 substantially extends along a spine axis Z. The test device 1 comprises at least one clavicle assembly 3. The test device 1 further comprises at least one arm assembly 4. Since the test device is designed to mimic a human body and is intended to behave as identical as possible to a human body in tests, the clavicle assembly 3 and arm assembly 4 are arranged relative to the spine assembly 2 in the same way a clavicle is arranged relative to the spine and arm in a human body. The clavicle assembly 3 is connected to the chest assembly that is generally designated by the numeral 15. The chest assembly 15 is connected to the spine assembly 2. The arm assembly 4 is connected to the clavicle assembly 3. The clavicle assembly 3 substantially extends in a radial direction with respect to the spine axis Z from the spine assembly 2. The arm assembly 4 is spaced away from the spine assembly 2 in a radial direction with respect to the spine axis Z. The arm assembly 4 is connected to the clavicle assembly 3. Thus, the clavicle assembly 3 is arranged between the spine assembly 2 and arm assembly 4 and connects the spine assembly 2 to the arm assembly 4.

The test device 1 comprises a shoulder assembly 5. The shoulder assembly 5 is connected to the clavicle assembly 3. The shoulder assembly 5 is arranged adjacent to the arm assembly 4, which extends away from the shoulder assembly 5 in a direction that lies generally parallel to the spine axis Z. The shoulder assembly 5 comprises a proximal portion 6 that is disposed proximally to the spine assembly 2. The proximal portion 6 is the portion of the shoulder assembly 5 which is located closest to the spine assembly 2. Compared to the human body, the shoulder assembly 5 represents the surface of the shoulder and the transition to the neck wherein the shoulder assembly 5 mimics a portion of the neck of a human body. Furthermore, as schematically shown in FIG. 1, the surface of the shoulder assembly 5 also covers the clavicle assembly 3. Accordingly, the proximal portion 6 is a portion of the shoulder assembly 5 that mimics the neck of a human body.

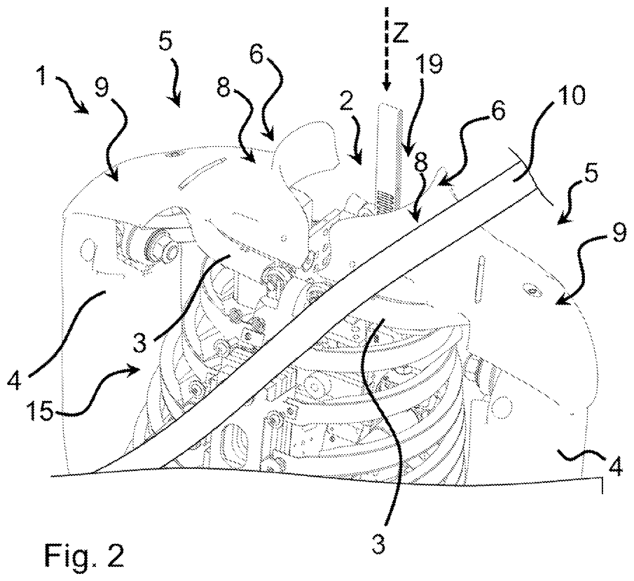

The shoulder assembly 5 comprises a distal portion 9 that is disposed distally to the spine assembly 2. Compared to the human body, the shoulder assembly 5 represents the surface of the shoulder up to the transition to the upper arm. Therefore, the distal portion 9 is the portion of the shoulder assembly 5 which is located furthest away from the spine assembly 2. Thus, compared to the human body, the distal portion 9 is the portion of the shoulder that covers the shoulder joint as shown in FIGS. 1 and 2.

The shoulder assembly 5 desirably is made of a plastic material. The shoulder assembly 5 is desirably at least partially made of a plastic. A plastic may be a thermoplastic, for example. A thermoplastic is soft and may be molded by energy input. Thermoplastics can be formed into a desired shape by molding processes and retain their shape after the molding process. A plastic may be a thermosetting plastic, for example. Thermosetting plastics are shaped in a molding process and retain their shape after a curing process. The curing process is usually performed by heating, oxidizing agents, high-energy radiation, or the use of catalysts.

According to the invention, the shoulder assembly 5 defines a seat belt portion that is generally designated by the numeral 8 in FIGS. 1-4 and 7. The seat belt portion 8 is arranged between the proximal portion 6 and the distal portion 9. Between is explicitly understood herein to mean that the seat belt portion 8 does not overlap with the proximal portion 6. As seen in a radial direction with respect to the spine assembly 2, the seat belt portion 8 does not extend immediately from the beginning, i.e., the point located closest to the shoulder assembly 5. Between is explicitly understood herein to mean that the seat belt portion 8 does not overlap with the distal portion 9. As seen in a radial direction with respect to the spine assembly 2, the seat belt portion 8 does not extend up to the end, i.e., the point located furthest away from the shoulder assembly 5. The seat belt portion 8 is configured and disposed to receive and underlie where the seat belt 10 crosses the shoulder assembly 5 during a disposition of the test crash dummy in a seat 13 of a vehicle 12 during performance of a crash test as schematically shown in FIG. 5.

According to the invention, the elasticity of the seat belt portion 8 is different from the elasticity of the distal portion 9. This has the advantage that in the event of an impact, then the seat belt 10 remains located in the seat belt portion 8 and does not slip into a gap 19, which is generally designated by the numeral 19 in FIGS. 1, 2 and 7, and is situated between the spine assembly 2 and shoulder assembly 5. Such slippage and repositioning of the seat belt 10 may happen in the event of an impact with a shoulder assembly 5 that does not include the seat belt portion 8 according to the present invention.

In a first embodiment of the test device 1, the seat belt portion 8 is more rigid than the distal portion 9. When the test device 1 is buckled with a seat belt 10 for performing a test in a vehicle 12, the seat belt 10 extends over the seat belt portion 8 of the shoulder assembly 5 as schematically shown in FIG. 2. During a collision of the vehicle 12, the test device 1 is pressed against the seat belt due to its inertial mass. The seat belt portion 8 included in the shoulder assembly 5 prevents significant deformation or mechanical folding of the shoulder assembly 5 in this area. Thus, the seat belt 10 remains positioned in the seat belt portion and cannot slip into the gap 19 between the spine assembly 2 and the shoulder assembly 5 as it may happen during an impact with a shoulder assembly 5 that does not include a seat belt portion 8.

In the first embodiment of the test device 1, the seat belt portion 8 preferably is more rigid than the proximal portion 6, and thus prevents the seat belt from slipping in the direction of the arm assembly 4.

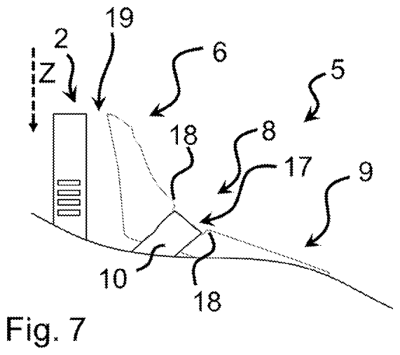

In the second embodiment of the test device, the seat belt portion 8 is more flexible than the proximal portion 6. When the test device 1 is buckled with a seat belt 10 for performing a test in a vehicle 12, seat belt 10 extends over the seat belt portion 8 of the shoulder assembly 5 as schematically shown in FIG. 2. In the event of a collision of the vehicle 12, the test device 1 is pressed against the seat belt due to the inertial mass of the test device 1. Since the seat belt portion 8 has a higher elasticity, the seat belt 10 sinks into the seat belt portion 8 during an impact. This forms a depression, which is generally designated by the numeral 17 in FIG. 7, in the seat belt portion 8. The depression 17 functions as a guiding means for the seat belt 10 as shown schematically in FIG. 7. FIG. 7 shows a schematic representation of an embodiment of a test device with only the right shoulder assembly 5 and the spine assembly 2 shown. Lateral slipping of the seat belt is prevented by the edges 18 of the depression 17. An edge 18 is present at least in the transition region from the seat belt portion 8 to the proximal portion 6 since the proximal portion 6 is more rigid than the seat belt portion 8. Therefore, the seat belt 10 remains in its position and cannot slip into the gap 19 between the spine assembly 2 and the shoulder assembly 5 as it may happen during an impact with a shoulder assembly 5 not including a seat belt portion 8 that is formed of material relatively more flexible than the material forming the proximal portion 6.

In the second embodiment of the test device 1, the seat belt portion 8 preferably is more flexible than the distal portion 7, and thus prevents the seat belt from slipping in the direction of the arm assembly 4.

A difference in elasticity of two portions in the context of the present document means that an elasticity of the first portion differs from the elasticity of a second portion, to which second portion the elasticity of the first portion is compared, by at least 10%.

A first portion is understood to be more rigid in the context of the present document when the elasticity of the first portion is at least 10% lower than the elasticity of a second portion, to which second portion the elasticity of the first portion is compared. In the first embodiment of the invention, the first portion is for example the seat belt portion 8. In the first embodiment of the invention, the second portion is for example the proximal portion 6 or distal portion 9.

A first portion is understood to be more flexible in the context of the present document when the elasticity of the first portion is at least 10% higher than the elasticity of a second portion, to which second portion the elasticity of the first portion is compared. In the first embodiment of the invention, the first portion is for example the proximal portion 6 and/or the distal portion 9. In the first embodiment of the invention, the second portion is for example the seat belt portion 8. The seat belt portion 8 extends between the proximal portion 6 and distal portion 9 such that the proximal portion 6 and distal portion 9 are arranged on both sides of the seat belt portion 8.

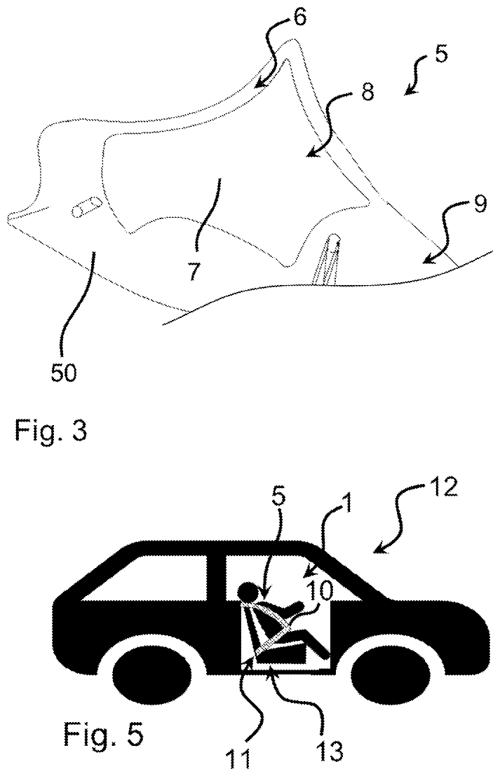

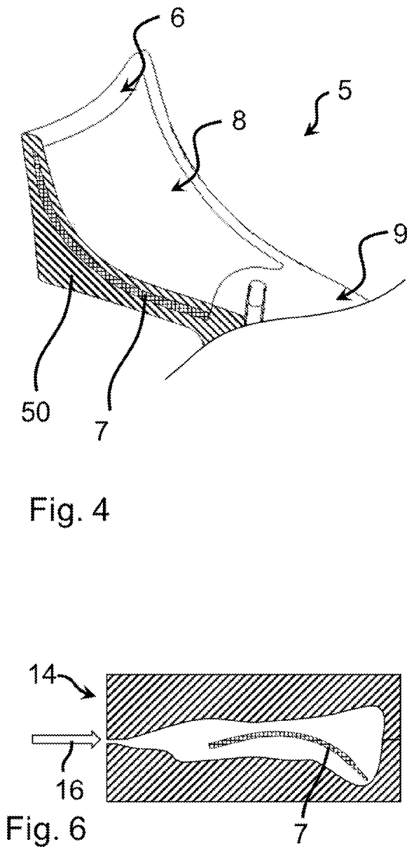

In a presently preferred embodiment, the shoulder assembly 5 comprises an insert 7. In this case, the shoulder assembly 5 also comprises a shoulder molded part 50 schematically shown in FIGS. 3 and 4 for example. The insert 7 is made of a material with different mechanical properties from the mechanical properties of the material forming the shoulder molded part 50 as shown in FIG. 3 and FIG. 4. To choose different materials, each with different mechanical properties, allows for better fine tuning of the dynamic reaction of the shoulder molded part 50 to an impact. In particular, the elasticity and, thus, deformability of the shoulder assembly 5 may be easily adjusted.

FIG. 3 shows the shoulder molded part 50 in transparent representation with an insert 7 embedded in the shoulder molded part 50. Transparent representation means that both the structures located on the side of the viewer and the structures on the side of the shoulder assembly 5 opposite from that of the viewer are visible.

The material of the insert 7 has an elasticity different from the elasticity of the material of the shoulder molded part 50.

In the first embodiment of the test device 1, the material of the insert 7 has a lower elasticity than the material of the shoulder molded part 50. This has the advantage that the shoulder assembly 5 has a higher rigidity in the region of the insert 7. Therefore, the seat belt portion 8 can be easily formed in the region where the insert 7 is located in the shoulder molded part 50.

In the second embodiment of the test device 1, the material of the insert 7 has a higher elasticity than the material of the shoulder molded part 50. This has the advantage that the shoulder assembly 5 has a higher flexibility in the region of the insert 7. Material having increased deformability is softer and more flexible. Thus, the seat belt portion 8 of the second embodiment of the test device 1 can be easily formed in the region where the insert 7 is located in the shoulder molding part 50.

In one embodiment, the shoulder molded part 50 is made of polyurethane. Polyurethane may be easily molded. For example, this may be done in a negative mold. Polyurethane may be either a thermoset or a thermoplastic. In each case, the liquid starting material is introduced into a negative mold of the shoulder molded part 50 and hardens within the negative mold. The insert 7 is positioned in the negative mold before the polyurethane is introduced. The feature of this embodiment may be used advantageously in combination with both the first embodiment of the test device 1 and the second embodiment of the test device 1.

In a presently preferred embodiment, the shoulder molded part 50 completely surrounds the insert 7. This is for example achieved by positioning the insert 7 appropriately in the negative mold. This has the advantage that the shoulder assembly 5 is devoid of any seams or edges in the region where the insert 7 is inserted in the shoulder molded part 50. A seat belt might get caught on seams or edges and thereby exert strong forces locally onto the shoulder molded part 50. In addition, the shoulder molded part 50 may be designed in such a way that the insert 7 is not visible from the outside which is the case when the material of the shoulder molded part 50 is opaque. In addition, also the external structure of the shoulder assembly 5 is still uniform. Thus, the biomechanical surface condition of the shoulder assembly 5 is uniform. The feature of this embodiment may be advantageously used in combination with both the first embodiment of the test device 1 and the second embodiment of the test device 1.

Insert 7 is particularly preferably arranged within the shoulder molded part 50 in such a way that the seat belt portion 8 is formed. The seat belt portion 8 may be shaped freely due to the shape and elasticity of the material of the insert 7. The feature of this embodiment may be advantageously used in combination with both the first embodiment of the test device 1 and the second embodiment of the test device 1.

Particularly preferably, the shoulder molded part is made of one piece. Made of one piece means that it is cast in a single casting or made of a solid material. The feature of this embodiment may be advantageously used in combination with both the first embodiment of the test device 1 and the second embodiment of the test device 1.

In the first embodiment of the test device 1, the material of the insert 7 particularly preferably is more rigid than the material of the shoulder molded part 50. In this way, an insert 7 is more rigid than the material of the shoulder molded part 50 while the geometry is the same. Thus, the seat belt portion 8 may be simply formed in the region of the insert 7 and the external geometry of the shoulder assembly 5 with respect to the current state of the art according to Tylko et al. is still kept the same.

In the second embodiment of the test device 1, the material of the insert 7 particularly preferably is more flexible than the material of the shoulder molded part 50. In this way, an insert 7 is more flexible than the material of the shoulder molded part 50 while the geometry is the same. Thus, the seat belt portion 8 may be simply formed in the region of the insert 7 and the external geometry of the shoulder assembly 5 with respect to the current state of the art according to Tylko et al. is still kept the same.

A test device 1 as described above is used in a vehicle 12 as schematically shown in FIG. 5. Vehicle 12 comprises a restraint device 11. The restraint device 11 comprises at least a seat belt 10, which has a strap that extends across the waist portion of the test device 1 and a strap that extends across the shoulder assembly 5 of the test device 1. Vehicle 12 comprises at least a seat 13. The test device 1 is placed on the seat 13. The seat belt 10 is arranged to be contact with the shoulder assembly 5. The seat belt 10 contacts the shoulder assembly 5 in the seat belt portion 8 of the shoulder assembly 5.

In the first embodiment of the test device 1, the seat belt portion 8 advantageously prevents the seat belt 10 from effecting deformation or mechanical folding of the shoulder assembly 5 during a collision of the vehicle 12. This prevents slipping of the seat belt 10 during such collision.

In the second embodiment of the test device 1, the seat belt portion 8 advantageously prevents slipping of the seat belt by forming a depression 17 in the seat belt portion 8 of the shoulder assembly 5 in the event of a collision of the vehicle 12. This prevents slipping of the seat belt 10 during such collision.

Particularly preferably, the restraint device 12 comprises a 3-point seat belt or a shoulder seat belt or a five-point seat belt. In each case, these seat belt 10 variations are at least partially arranged over the shoulder assembly 5 when a test device 1 is placed in a vehicle 12 having this seat belt 10.

A presently preferred process for manufacturing a shoulder assembly 5 for a test device 1 includes the step of providing an insert 7. In a further step, the insert 7 is introduced into a hollow mold 14 as shown in FIG. 6. A hollow mold 14 is for example a hollow mold 14 of an injection molding machine. A hollow mold 14 is also known as a negative mold or a casting mold. In a further step schematically represented by the arrow designated by the numeral 16 in FIG. 6, hollow mold 14 is filled with casting material 16. The casting material 16 is preferably a plastic. Generally, thermosets or thermoplastics are preferred in injection molding. Particularly preferably, the casting material is polyurethane. In a further step, the hollow mold 14 is filled with casting material 16 in such a way that the casting material 16 at least partially surrounds the insert 7. In a presently preferred embodiment, the hollow mold 14 is filled with casting material 16 so that the casting material 16 surrounds the insert 7. Thus, the casting material 16 forms the shoulder molded part 50 that includes an embedded insert 7, which forms a seat belt portion 8.

The manufacturing process is suitable for manufacturing a shoulder assembly 5 for the first embodiment of the test device 1 as original equipment.

The manufacturing process is also suitable for manufacturing a shoulder assembly for the second embodiment of the test device 1 as original equipment.

Particularly advantageously, the insert 7 is manufactured by means of 3D printing. In this way, the shape of the insert 7 may be adapted specifically to the shape of the shoulder assembly 5 so that the insert 7 at least partially has the same shape as the shoulder assembly 5. For example, a layer of the shoulder molded part 50 in the seat belt portion 8 covering the insert 7 may be made with constant thickness and/or with a density that differs from the density of the surrounding material in the structure.

In one embodiment, insert 7 includes acrylonitrile-butadiene-styrene copolymers.

In the first embodiment of the test device 1, the material of the insert 7 preferably has a Young's modulus of between 1000 MPa (megapascals) and 2000 MPa according to ASTM D638.

A pre-existing shoulder assembly 5 desirably can be retrofitted in accordance with the present invention. The retrofitting method involves machining a cut out from the region of the pre-existing shoulder assembly 5 where the insert 7 is desired to be located in the pre-existing shoulder assembly 5. The region for the cut out desirably would be the region designated by the numeral 17 in FIG. 7 for example. The insert 7 is placed into the cut out, which then is filled with material emulating the material surrounding the cut out, which material then is cured or otherwise hardened. The resulting surface of the shoulder assembly 5 can be machined smooth to eliminate any discontinuities in the surface that otherwise might cause the shoulder strap 10 of the restraint device 11 to become snagged and introduce unwanted forces that diminish the reliability of the test data to emulate the forces acting on an occupant during a collusion of the vehicle 12.

The first embodiment of the test device 1 disclosed herein cannot be combined with the second embodiment of the test device 1. However, other embodiments described of the test device 1 may be readily combined with the first embodiment of the test device 1 and/or the second embodiment of the test device 1.

### List of Reference Numerals

Z spine axis
1 test device
2 spine assembly
3 clavicle assembly
4 arm assembly
5 shoulder assembly
6 proximal portion
7 insert
8 seat belt portion
9 distal portion
10 seat belt
11 restraint device
12 vehicle
13 seat
14 hollow mold
15 chest assembly
16 casting material
17 depression
18 edge
19 gap
50 shoulder molded part

What is claimed is:

1. An anthropomorphic test device, comprising:
a spine assembly that extends substantially along a spine axis;
a clavicle assembly connected to the spine assembly and extending substantially radially from the spine axis;
an arm assembly disposed spaced away from the spine assembly in a direction radially from the spine axis; and
a shoulder assembly connected to the clavicle assembly and disposed adjacent to the arm assembly and defining a proximal portion disposed proximal to the spine assembly and defining a distal portion disposed distal to the spine assembly;
wherein the shoulder assembly further defines a seat belt portion that is disposed between the proximal portion and the distal portion and that has an elasticity that differs from the elasticity of the distal portion.

2. The test device according to claim 1, wherein the shoulder assembly includes an insert made of a first material and a shoulder molded part made of a second material that differs from the first material.

3. The test device according to claim 2, wherein the seat belt portion is more rigid than the distal portion.

4. The test device according to claim 2, wherein the seat belt portion is more flexible than the proximal portion.

5. The test device according to claim 2, wherein the shoulder assembly is at least partially made of plastic.

6. The test device according to claim 2, wherein the elasticity of the material of the insert is different from the elasticity of the material of the shoulder molded part.

7. The test device according to claim 2, wherein the shoulder molded part is made of polyurethane.

8. The test device according to claim 2, wherein the shoulder molded part completely surrounds the insert.

9. The test device according to claim 2, wherein the insert is disposed within the shoulder molded part in such a way that the insert forms the seat belt portion.

10. The test device according to claim 2, wherein the shoulder molded part is made of one piece.

11. The test device according to claim 2, wherein the material of the insert has a Young's modulus of between 1000 MPa and 2000 MPa.

12. A test system for measuring forces associated with trauma suffered by a person occupying a seat of a crashed vehicle, the system comprising:
a vehicle;
a seat carried by the vehicle;
a restraint device carried by the vehicle and including a seat belt having one end anchored to the vehicle, the restraint device being configured for restraining the occupant in the seat when the vehicle is crashed; and
an anthropomorphic test device that is carried by the seat and that includes:
a spine assembly that extends substantially along a spine axis,
a clavicle assembly connected to the spine assembly and extending substantially radially from the spine axis,
an arm assembly disposed spaced away from the spine assembly in a direction radially from the spine axis, and
a shoulder assembly connected to the clavicle assembly and disposed adjacent to the arm assembly and defining a proximal portion disposed proximal to the spine assembly and defining a distal portion disposed distal to the spine assembly,
wherein the shoulder assembly further defines a seat belt portion that is disposed between the proximal portion and the distal portion and that has an elasticity that differs from the elasticity of the distal portion;
wherein the seat belt is disposed in contact with the seat belt portion of the shoulder assembly.

13. The test system according to claim 12, wherein the seat belt of the restraint device includes a shoulder seat belt.

14. A process for manufacturing a shoulder assembly for a test device, the process comprising the following steps:
providing a spine assembly that extends substantially along a spine axis;
connecting a clavicle assembly to the spine assembly so that the clavicle assembly extends substantially radially from the spine axis;
disposing an arm assembly spaced away from the spine assembly in a direction radially from the spine axis;
providing a shoulder assembly made of a first material and defining a hollow mold, a proximal portion, a distal portion and a seat belt portion that is disposed between the proximal portion and the distal portion and has an elasticity that differs from the elasticity of the distal portion;
disposing adjacent to the arm assembly, the shoulder assembly with the proximal portion disposed proximal to the spine assembly and the distal portion disposed distal to the spine assembly;
connecting the shoulder assembly to the clavicle assembly;
providing an insert made of a second material that differs from the first material;
introducing the insert into the hollow mold;
filling the hollow mold with casting material so that the casting material surrounds the insert.

15. The process for manufacturing a shoulder assembly for a test device according to claim 14, wherein the insert is provided by being manufactured by means of 3D printing.

16. The test device according to claim 2, wherein the seat belt portion is more rigid than the proximal portion.

17. The test device according to claim 2, wherein the seat belt portion is more flexible than the distal portion.

18. The test system according to claim 12, wherein the seat belt of the restraint device is configured as a multi-point seat belt.
